(19) United States
(12) Patent Application Publication
(10) Pub. No.: US 2019/0026911 A1
(43) Pub. Date: Jan. 24, 2019

(54) DISTANCE IMAGE PROCESSING DEVICE, DISTANCE IMAGE ACQUISITION DEVICE, AND DISTANCE IMAGE PROCESSING METHOD

(71) Applicant: FUJIFILM Corporation, Tokyo (JP)

(72) Inventors: Yoshinori FURUTA, Saitama-shi (JP); Tomoyuki KAWAI, Saitama-shi (JP); Tomonori MASUDA, Saitama-shi (JP)

(73) Assignee: FUJIFILM Corporation, Tokyo (JP)

(21) Appl. No.: 16/138,026

(22) Filed: Sep. 21, 2018

Related U.S. Application Data
(63) Continuation of application No. PCT/JP2017/010386, filed on Mar. 15, 2017.

(30) Foreign Application Priority Data
Mar. 31, 2016 (JP) 2016-071923

(51) Int. Cl. G06T 7/50; G06K 9/46; G06K 9/40

(52) U.S. Cl. CPC G06T 7/50; G06K 9/40; G06K 9/46

(57) ABSTRACT

A distance image processing device, a distance image acquisition device, and a distance image processing method that enable acquisition of a distance image with high precision and high visibility in the case of short range measurement are provided. A distance image processing device includes a first discrimination unit that discriminates a pixel having a distance value exceeding a certain distance range among a plurality of pixels of a distance image as an abnormal pixel, a second discrimination unit that discriminates the abnormal pixel discriminated by the first discrimination unit as a first abnormal pixel that is continuous and a second abnormal pixel that is not continuous, and a clipping processing unit that changes a distance value of the first abnormal pixel into a certain value.

### CROSS-REFERENCE TO RELATED APPLICATIONS

The present application is a Continuation of PCT International Application No. PCT/JP2017/010386 filed on Mar. 15, 2017 claiming priority under 35 U.S.C § 119(a) to Japanese Patent Application No. 2016-071923 filed on Mar. 31, 2016. Each of the above applications is hereby expressly incorporated by reference, in their entirety, into the present application.

### BACKGROUND OF THE INVENTION

### 1. Field of the Invention

The present invention relates to a distance image processing device, a distance image acquisition device, and a distance image processing method for performing a process on a distance image including a plurality of distance values corresponding to a time of flight of light, and more particularly, to a technology for enabling acquisition of a distance image with high precision and high visibility in the case of short range measurement.

### 2. Description of the Related Art

A distance measurement technology using a time of flight (TOF) scheme in which light emitted from a light emitting unit and reflected by a distance measurement area is guided to a light reception surface of an imaging unit by a lens, distance values of a plurality of points corresponding to a TOF of light from light emission to light reception are calculated on the basis of an imaging result of the imaging unit, and a viewable distance image is acquired has been known.

JP1995-71957A (JP-H07-71957A) describes that, in distance measurement using a TOF scheme, a distance value exceeding a short distance range is excluded.

JP2015-175752A describes that in distance measurement using a TOF scheme, parameters of a smoothing filter are determined according to a size of a target, and a pixel value of a distance image is smoothed.

JP2010-256138A describes that in distance measurement using a TOF scheme, a distance image and surface shape information (which is an azimuth angle of a normal to a surface) are simultaneously acquired, an area in which a distance value is spatially discontinuous and a surface shape is continuous in the distance image is determined to be a disturbance area and removed, and supplementation is performed with a median value of distance values of nearby pixels to solve a multiple reflection problem.

### SUMMARY OF THE INVENTION

In distance measurement using a TOF scheme, a correct distance value cannot be obtained due to multiple reflection in some cases. In particular, in a case where a distance measurement range is limited to a short distance, abnormality of the distance value due to the multiple reflection becomes noticeable. For example, in a case where the distance measurement using the TOF scheme is applied to an endoscope device and a distance image is acquired, a large number of outliers indicating a long distance may be generated in the distance image with respect to a measurement distance range of about several tens of centimeters. Further, for example, in the case of high sensitivity imaging, minute noise due to an electric factor is noticeably generated in the distance image, as well as the abnormality in the distance value occurs due to the multiple reflection.

JP1995-71957A (JP-H07-71957A) merely describes that the distance value exceeding the short distance range is excluded.

JP2015-175752A merely describes a noise removal technology for smoothing the pixel values of the distance image. Therefore, in the case of short distance measurement, since the abnormality of the distance value caused by the multiple reflection becomes apparent, a distance image with high precision and high visibility is likely to be unable to be output. This is because, in a case where a half or more of nearby pixels have abnormal values due to the multiple reflection, the abnormal value cannot be corrected with an appropriate value even in a case where the abnormal value is smoothed on the basis of the distance value of nearby pixels.

In the technology of JP2010-256138A, since not only first imaging means for acquiring the distance image but also second imaging means for acquiring surface shape information is required, a device size and a device cost increase. In addition, in a case where the multiple reflection is noticeable, the distance image with high visibility is likely to be unable to be output. This is because, in a case where a half or more of nearby pixels have abnormal values due to the multiple reflection, an area determined to be a disturbance area cannot be complemented with an appropriate distance value even in a case where the area determined to be the disturbance area is complemented with a median value of nearby pixels.

JP1995-71957A (JP-H07-71957A), JP2015-175752A, and JP2010-256138A do not disclose a technology for discriminating between an abnormal pixel caused by multiple reflection and a minute noise pixel due to an electric factor on the basis of only the distance image, and do not disclose a technology for presenting a distance image with high visibility by making image processing different between the abnormal pixel caused by the multiple reflection and the minute noise pixel. Therefore, even in a case where the plurality of related arts described above can be combined, it may be difficult to acquire a distance image with high precision and high visibility.

The present invention has been made in view of the above circumstances, and an object of the present invention is to provide a distance image processing device, a distance image acquisition device, and a distance image processing method that enable acquisition of a distance image with high precision and high visibility in the case of short range measurement.

In order to achieve the above object, a distance image processing device according to a first aspect of the present invention comprises: a distance image input unit that inputs a distance image including a plurality of pixels having a distance value corresponding to a time of flight of light from light emission to light reception; a first discrimination unit that discriminates a pixel having a distance value exceeding a certain distance range among the plurality of pixels as an abnormal pixel; a second discrimination unit that discriminates the abnormal pixel discriminated by the first discrimination unit as a first abnormal pixel that is continuous and a second abnormal pixel that is not continuous; and a clipping processing unit that changes a distance value of the first abnormal pixel into a certain value.

According to this aspect, in a case where the pixel having the distance value exceeding the certain distance range among the plurality of pixels is discriminated as an abnormal pixel and is also discriminated as the first abnormal pixel that is continuous, the distance value of the first abnormal pixel is changed into a certain value, and therefore, the distance image with higher accuracy and higher visibility than in related art can be acquired in a case where multiple reflection is apparent in short distance measurement.

In the distance image processing device according to the second aspect of the present invention, the certain value is an upper limit value of the certain distance range, and the clipping processing unit changes the distance value of the first abnormal pixel into the upper limit value of the distance range. According to this aspect, in a case where multiple reflection is apparent in short distance measurement, an outlier caused by multiple reflection is clipped to the upper limit value of a certain distance range that is the measurement range, and therefore, a distance image that is easy to view can be acquired.

The distance image processing device according to a third aspect of the present invention further comprises: a noise processing unit that changes a distance value of the second abnormal pixel on the basis of distance values of pixels around the second abnormal pixel. According to this aspect, for example, in a case where generation of minute noise due to high-sensitivity imaging becomes apparent together with generation of an abnormal value caused by multiple reflection, the pixel of minute noise is changed on the basis of the distance values of nearby pixels, and therefore, it is possible to acquire the distance image with high accuracy and high visibility.

In the distance image processing device according to the fourth aspect of the present invention, the second discrimination unit performs discrimination as to whether or not the abnormal pixel is the first abnormal pixel on the basis of the number of the abnormal pixels in an area having a fixed size with reference to each of the abnormal pixels discriminated by the first discrimination unit. According to this aspect, abnormal pixels caused by multiple reflection can be appropriately determined.

In the distance image processing device according to the fifth aspect of the present invention, the second discrimination unit switches a threshold value that is used for discrimination as to whether or not the abnormal pixel is the first abnormal pixel according to an upper limit value of the distance range.

In the distance image processing device according to the sixth aspect of the present invention, the second discrimination unit switches a threshold value that is used for discrimination as to whether or not the abnormal pixel is the first abnormal pixel according to imaging sensitivity in a case where the distance image is acquired.

The distance image processing device according to a seventh aspect of the present invention further comprises a setting input unit that receives a setting input of the certain value.

In the distance image processing device according to the eighth aspect of the present invention, the noise processing unit performs noise processing using a smoothing filter or a median filter.

The distance image processing device according to a ninth aspect of the present invention further comprises: a display control unit that causes a display device to display the plurality of pixels of the distance image with colors according to the respective distance values.

A distance image acquisition device according to a tenth aspect of the present invention comprises: a light emitting unit that emits light; an imaging unit that includes a light reception surface on which a plurality of light reception elements are arranged; an optical system that guides the light emitted from the light emitting unit and reflected in a distance measurement area to the light reception surface of the imaging unit; a distance image generation unit that generates a distance image including a plurality of pixels having distance values corresponding to a time of flight of light from light emission of the light emitting unit to the light reception surface of the imaging unit on the basis of an imaging result of the imaging unit; a first discrimination unit that discriminates the pixel having the distance value exceeding a certain distance range among the plurality of pixels as an abnormal pixel; a second discrimination unit that discriminates the abnormal pixel discriminated by the first discrimination unit as a first abnormal pixel that is continuous and a second abnormal pixel that is not continuous; and a clipping processing unit that changes a distance value of the first abnormal pixel into a certain value.

In the distance image acquisition device according to the eleventh aspect of the present invention, the certain value is an upper limit value of the certain distance range.

The distance image acquisition device according to a twelfth aspect of the present invention further comprises a noise processing unit that changes a distance value of the second abnormal pixel on the basis of distance values of pixels around the second abnormal pixel.

A distance image processing method according to a thirteenth aspect of the present invention comprises the steps of: inputting a distance image including a plurality of pixels having a distance value corresponding to a time of flight of light from light emission to light reception; discriminating a pixel having a distance value exceeding a certain distance range among the plurality of pixels as an abnormal pixel; discriminating the discriminated abnormal pixel as a first abnormal pixel that is continuous and a second abnormal pixel that is not continuous; and changing a distance value of the first abnormal pixel into a certain value.

In the distance image processing method according to a fourteenth aspect of the present invention, the certain value is an upper limit value of the certain distance range.

The distance image processing method according to a fifteenth aspect of the present invention further comprises the step of changing a distance value of the second abnormal pixel on the basis of distance values of pixels around the second abnormal pixel.

According to the present invention, it is possible to acquire a distance image with high precision and high visibility in the case of short distance measurement.

### BRIEF DESCRIPTION OF THE DRAWINGS

FIG. 1 is a block diagram illustrating an example of a configuration of a system including a distance image acquisition device and a distance image processing device according to a first embodiment.

FIG. 2 is a flowchart showing a flow of an example of distance image processing in the first embodiment.

FIG. 3 illustrates an example of a distance image including multiple reflection pixels and noise pixels.

FIG. 4 is an illustrative diagram that is used for description of an example of a clipping process.

FIG. 5 is an illustrative diagram that is used for description of an example of noise processing.

FIG. 6 is a block diagram illustrating an example of a configuration of a distance image acquisition device according to a second embodiment.

FIG. 7 is a flowchart showing a flow of an example of distance image processing in the second embodiment.

### DESCRIPTION OF THE PREFERRED EMBODIMENTS

Hereinafter, modes for carrying out a distance image processing device, a distance image acquisition device, and a distance image processing method according to the present invention will be described with reference to the accompanying drawings.

### First Embodiment

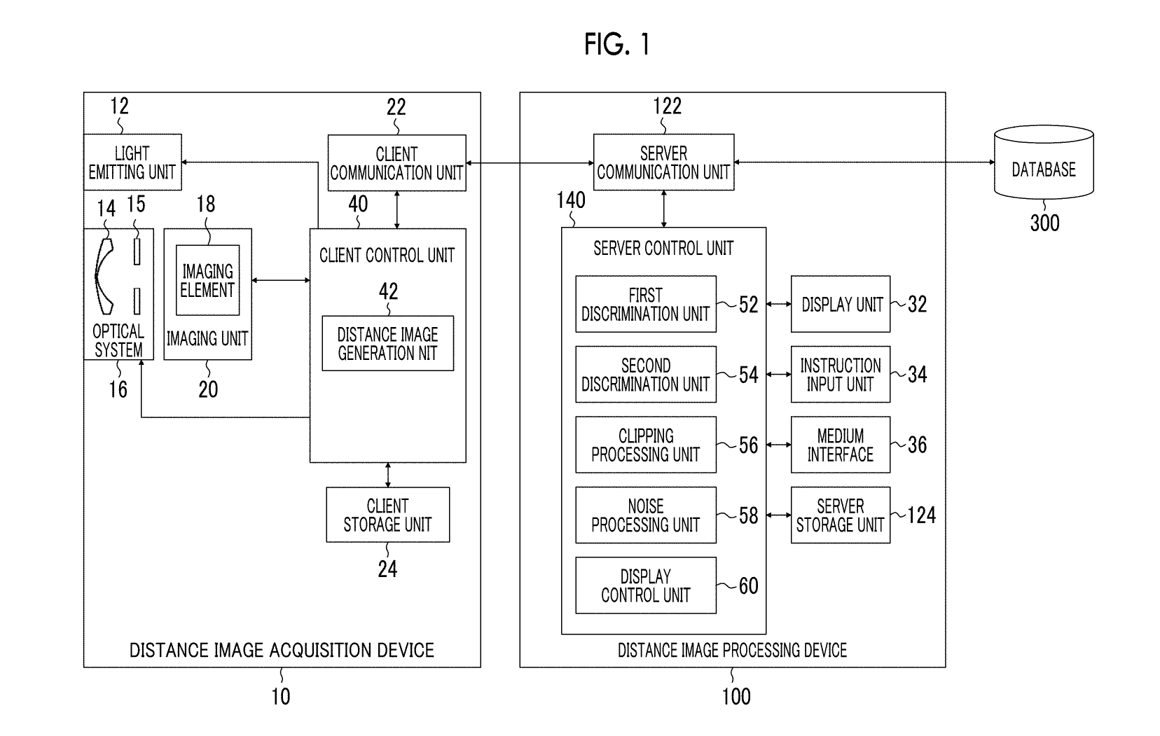

FIG. 1 is a block diagram illustrating an example of a configuration of a system including a distance image acquisition device and a distance image processing device according to a first embodiment.

The distance image acquisition device 10 includes a light emitting unit 12 that emits light, an optical system 16 that includes a lens 14 and an aperture 15, an imaging unit 20 that includes an imaging element 18 and has a light reception surface on which a plurality of light reception elements are two-dimensionally arranged, a client communication unit 22 that performs output and input of information to and from an external device (a distance image processing device 100 in this example), a client storage unit 24 that stores various types of information, and a client control unit 40 that controls each unit of the distance image acquisition device 10 according to a program stored in the client storage unit 24.

The light emitting unit 12 includes, for example, a light emitting diode (LED) that emits infrared light. Other light emitting devices may be used.

The lens 14 of the optical system 16 guides the light emitted from the light emitting unit 12 and reflected by the distance measurement area corresponding to an angle of view of the lens 14 to the light reception surface of the imaging element 18 of the imaging unit 20. The lens 14 may include a plurality of lenses.

For example, a complementary metal oxide semiconductor (CMOS) imaging sensor or a charge coupled device (CCD) imaging sensor is used as the imaging element 18 of the imaging unit 20. Other imaging devices may be used. The imaging element 18 includes a light reception surface on which a plurality of light reception elements are arranged. Photoelectric conversion elements including a filter that passes infrared light are two-dimensionally arranged as light reception elements on the light reception surface of the imaging element 18 of this example.

The client communication unit 22 includes a wired or wireless communication device.

The client storage unit 24 includes, for example, a read only memory (ROM), a random access memory (RAM), and an electrically erasable programmable read only memory (EEPROM). Other storage devices may be used.

The client control unit 40 includes, for example, a central processing unit (CPU).

The client control unit 40 of this example includes a distance image generation unit 42 that generates a distance image on the basis of an imaging result of the imaging unit 20. The distance image is an image including a plurality of pixels having distance values corresponding to the time of flight of light from light emission of the light emitting unit 12 to light reception of the imaging unit 20.

The distance image processing device 100 includes a display unit 32 that performs a display for a user, an instruction input unit 34 that receives an instruction input from the user, a medium interface 36 that is an interface for a recording medium such as a memory card, a server communication unit 122 that performs output and input of information to and from an external device (the distance image acquisition device 10 and a database 300 in this example), a server storage unit 124 that stores various types of information, and a server control unit 140 that controls each unit of the distance image processing device 100 according to a program stored in the server storage unit 124.

The display unit 32 is a display device, and includes, for example, a liquid crystal display (LCD). An organic light emitting diode (OLED) display may be used.

The instruction input unit 34 includes, for example, a touch panel arranged to cover a screen of the display unit 32. The instruction input unit 34 may include a keyboard and a pointing device (for example, a mouse). Other input devices such as a voice input device or a gesture input device may be used.

The medium interface 36 performs writing of information to the recording medium and reading of information from the recording medium.

The server communication unit 122 includes a wired or wireless communication device. The server communication unit 122 of this example is one form of a “distance image input unit” in the present invention, and receives the distance image from the distance image acquisition device 10.

The server storage unit 124 includes, for example, a ROM, a RAM, and an EEPROM. Other storage devices may be used.

The server control unit 140 in this example includes a first discrimination unit 52 that discriminates a pixel having a distance value exceeding a certain distance range among a plurality of pixels of the distance image as an abnormal pixel, a second discrimination unit 54 that discriminates the abnormal pixel discriminated by the first discrimination unit 52 as a first abnormal pixel that is continuous and a second abnormal pixel that is not continuous, a clipping processing unit 56 that changes a distance value of the first abnormal pixel into a certain value, a noise processing unit 58 that changes a distance value of the second abnormal pixel on the basis of distance values of pixels located in the vicinity of the second abnormal pixel, and a display control unit 60 that displays the distance image on the display unit 32.

The first discrimination unit 52 of this example determines whether or not the distance value of each pixel of the distance image exceeds the upper limit value (for example, 1.0 m) of the measurement range of the short distance, and discriminates that the pixel having the distance value exceeding the upper limit value is an abnormal pixel.

The second discrimination unit 54 of this example discriminates the abnormal pixel discriminated by the first discrimination unit 52 as a first abnormal pixel which is continuous and a second abnormal pixel which is not continuous. That is, the second discrimination unit 54 discriminates whether or not the abnormal pixel is an abnormal pixel (the first abnormal pixel) caused by multiple reflection.

There are various aspects of discrimination as to whether or not the abnormal pixel is the “first abnormal pixel”.

For example, there is an aspect for discriminating whether or not the abnormal pixel is the “first abnormal pixel” by counting the number of abnormal pixels within an area having a fixed size with reference to each abnormal pixel in the distance image. For example, discrimination is made as to whether or not a large number (for example, half or more) of abnormal pixels are also present around the abnormal pixel of interest. That is, in a case where the number of abnormal pixels counted in an area having a fixed size with reference to the abnormal pixel of interest is a majority, the abnormal pixel of interest is discriminated as the “first abnormal pixel”. Here, the “area having a fixed size” is, for example, an area having a predetermined pixel size centered on the abnormal pixel of interest (which is the abnormal pixel discriminated by the first discrimination unit 52). The “predetermined pixel size” is preferably N×N pixels (N is 3 to 7) and may be, more preferably, 3×3 pixels.

Further, an aspect of the discrimination of the “first abnormal pixel” is not limited to the above-described aspect. As the determination of “the first abnormal pixel”, it may be detected that the abnormal pixels are continuous over a plurality of pixels.

The clipping processing unit 56 of this example changes the distance value of the first abnormal pixel into the upper limit value of the distance range of the short distance measurement.

The noise processing unit 58 of this example performs a noise removal process using filters such as a smoothing filter and a median filter. Examples of the smoothing filter include an averaging filter that gives the average values of nearby pixels to the abnormal pixel, and a Gaussian filter that increases a weight of the nearby pixels closer to the pixel of interest. The median filter gives a median value of the nearby pixels to the abnormal pixel. Further, the noise removal filter is not particularly limited to the example described above.

Here, the “nearby pixel” is a pixel located within a predetermined number of pixels from the abnormal pixel of interest (which is the abnormal pixel discriminated by the first discrimination unit 52). The “predetermined number of pixels” is preferably 1 to 3 and, more preferably, 1.

The display control unit 60 of this example displays a plurality of pixels of the distance image on the display unit 32 with colors corresponding to the respective distance values. The display control unit 60 in this example shows the distance value as a pixel value representing colors in which red (R), green (G), and blue (B) are used as three primary colors.

The database 300 of this example can store distance image, and correction information for correcting the distance image.

Next, an example of distance image processing to which the distance image processing method according to the present invention is applied will be described.

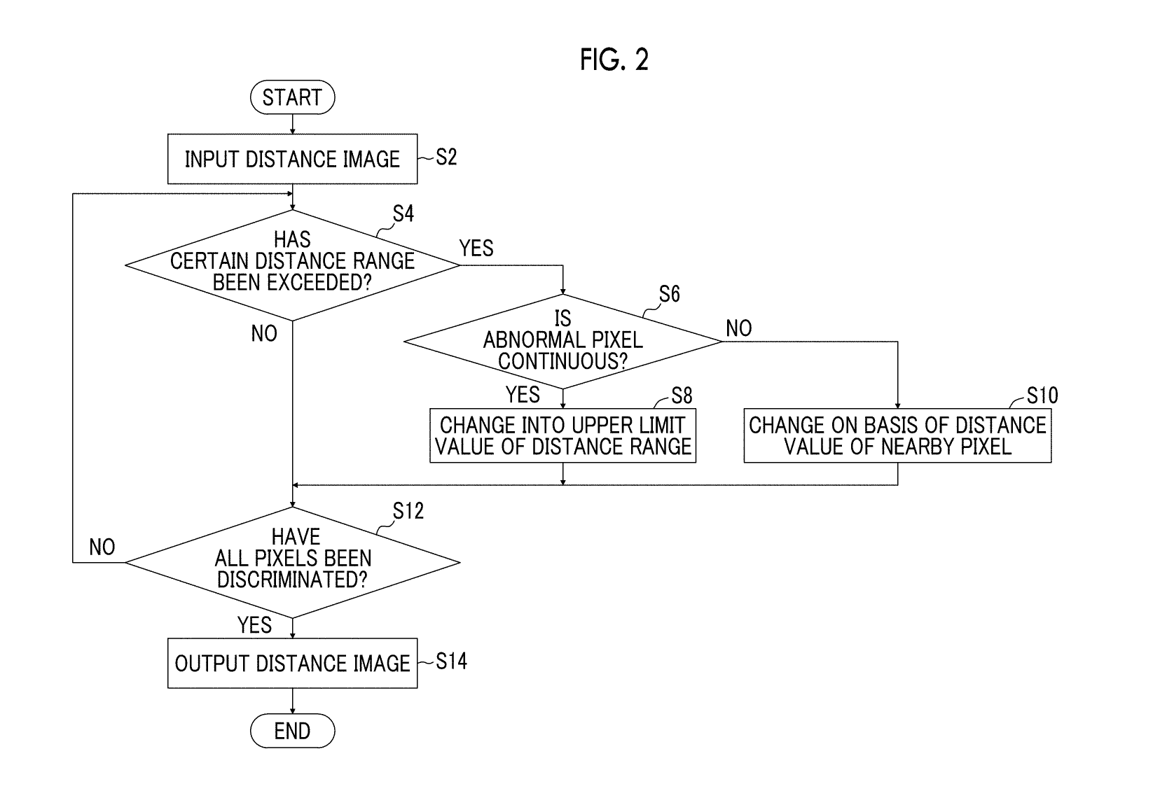

FIG. 2 is a flowchart showing a flow of an example of distance image processing in the first embodiment. The distance image processing of this example is executed by the server control unit 140 according to the program stored in the server storage unit 124.

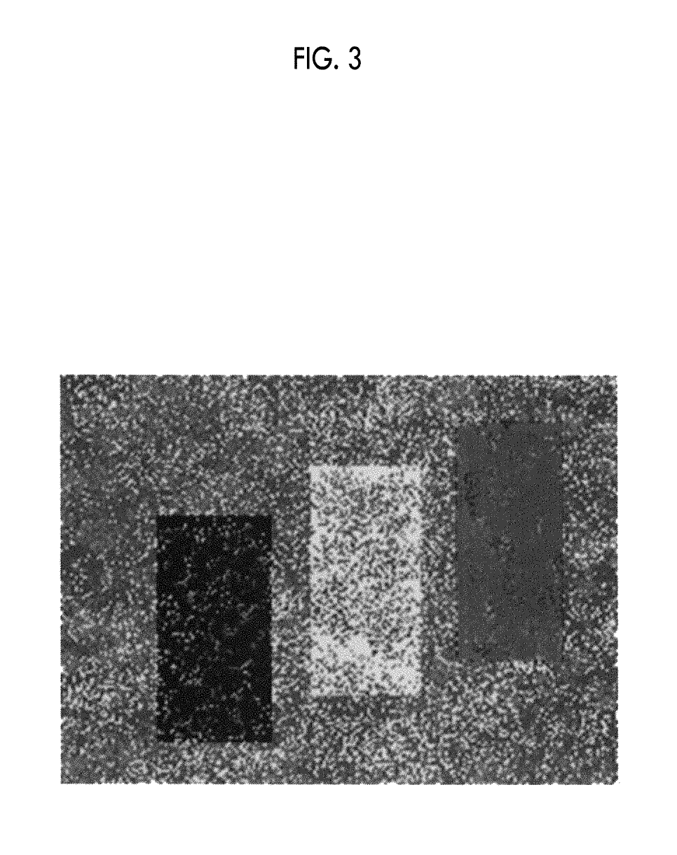

First, the server communication unit 122 receives a distance image from the distance image acquisition device 10 (step S2). The distance image stored in the database 300 may be input from the database 300 by the server communication unit 122. The distance image includes a plurality of pixels having a distance value according to a time of flight of light from light emission of the light emitting unit 12 to light reception on the light reception surface of the imaging unit 20. An example of the distance image illustrated in FIG. 3 includes multiple reflection pixels and noise pixels. Further, although the distance image is represented by gray scale for convenience of illustration in FIG. 3, the distance image of this example can be displayed with color on the display unit 32, and each pixel value of the distance image is a value indicating color associated with a magnitude of the distance value. Further, in FIG. 3, a continuous white area is an area of the first abnormal pixel (which is an abnormal pixel caused by multiple reflection). Further, in FIG. 3, a minute white point is the second abnormal pixel (noise pixel).

Next, the first discrimination unit 52 discriminates whether or not the distance value exceeds a measurement range of a short distance for each of the pixels constituting the distance image (step S4). That is, the first discrimination unit 52 discriminates that a pixel having the distance value exceeding a certain distance range is the abnormal pixel. For example, in a case where the measurement range of the short distance is equal to or smaller than 1.0 m, the first discrimination unit 52 discriminates that a pixel having a distance value exceeding 1.0 m is the abnormal pixel.

In a case where it is determined that the pixel is the abnormal pixel (YES in step S4), the second discrimination unit 54 discriminates whether the abnormal pixel is a first abnormal pixel that is continuous or a second abnormal pixel that is not continuous (step S6). In a case where it is determined that the pixel is the first abnormal pixel, that is, in a case where it is determined that the abnormal pixel discriminated by the first discrimination unit 52 is continuous (YES in step S6), the clipping processing unit 56 performs clipping processing to change the distance value of the first abnormal pixel into a certain value in the distance range (in this example, an upper limit value of the measurement distance range) (step S8).

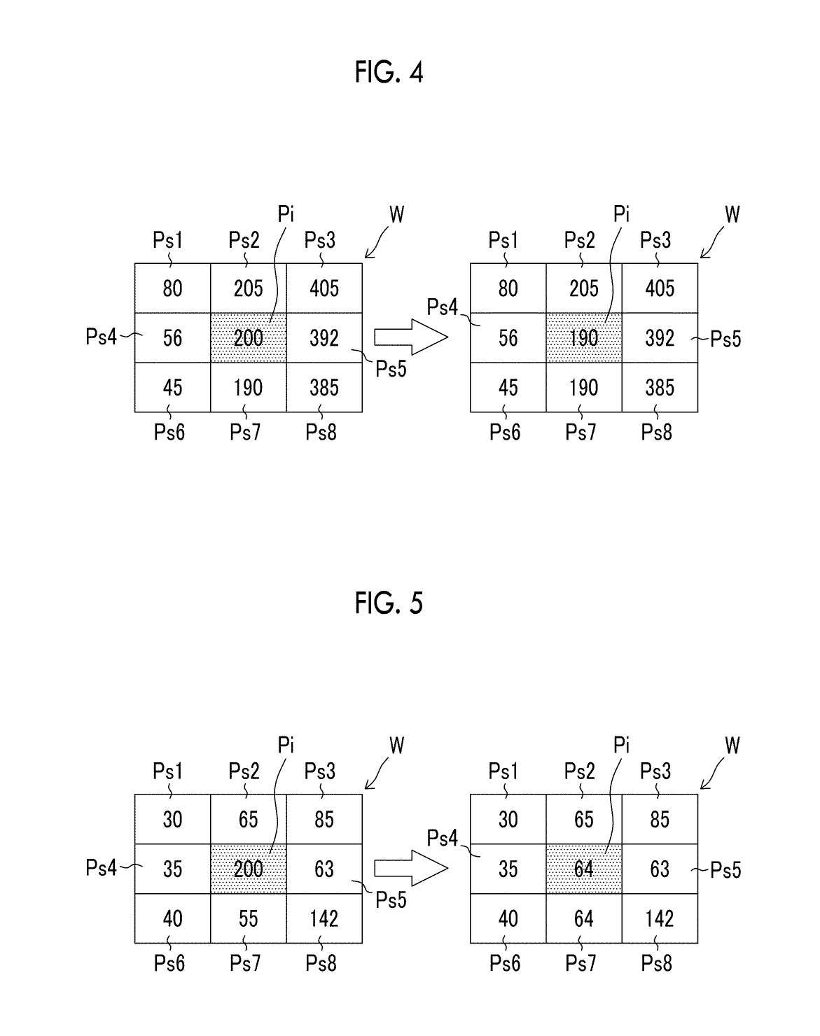

For example, as illustrated in FIG. 4, in a case where the distance value (“200” in this example) of the pixel of interest Pi exceeds the upper limit value (for example, “190”) of the distance measurement range and the number of pixels having the distance value exceeding “190” which is the upper limit value like the pixel Pi of interest (which is an abnormal pixel) among the pixels (the pixel of interest Pi and the nearby pixels Ps1, Ps2, Ps3, Ps4, Ps5, Ps6, Ps7, and Ps8) in the window of interest W having a fixed size (3×3 pixels in this example) is a majority (five or greater in this example), the distance value of the pixel Pi of interest is set to the upper limit value (for example, “190”) of the measurement distance measurement range.

In a case where it is determined that the pixel is the second abnormal pixel, that is, in a case where it is determined that the abnormal pixel determined by the first discrimination unit 52 is not continuous (NO in step S6), the noise processing unit 58 changes the distance value of the abnormal pixel on the basis of distance values of nearby pixels (step S10).

The noise processing unit 58 of this example performs smoothing on the second abnormal pixel. For example, as illustrated in FIG. 5, in a case where the distance value (for example, “200”) of the pixel Pi of interest exceeds the upper limit value (for example, “190”) of the distance measurement range and the number of pixels having the distance value exceeding “190” which is the upper limit value like the pixel Pi of interest (which is an abnormal pixel) among the pixels (the pixel of interest Pi and the nearby pixels Ps1 to Ps8) in the window of interest W is equal to or smaller than a half (equal to or smaller than 4 in this example), the pixel value (for example, “200”) of the pixel Pi of interest is changed into the average value (for example, “64”) of the distance values of the nearby pixels Ps1 to Ps8. The pixel value may be changed into a median value of the distance values of the nearby pixels Ps1 to Ps8.

A determination is made as to whether or all the pixels of the distance image have been discriminated (step S12). In a case where there is a pixel which has not yet been discriminated (NO in step S12), the process returns to step S4. In a case where all the pixels are discriminated (YES in step S12), the display control unit 60 outputs the distance image to the display unit 32 (step S14). The plurality of pixels of the distance image are displayed on the display unit 32 with colors corresponding to the respective distance values. The server communication unit 122 may output the distance image to the database 300. The distance image may be output to the recording medium by the medium interface 36.

### Second Embodiment

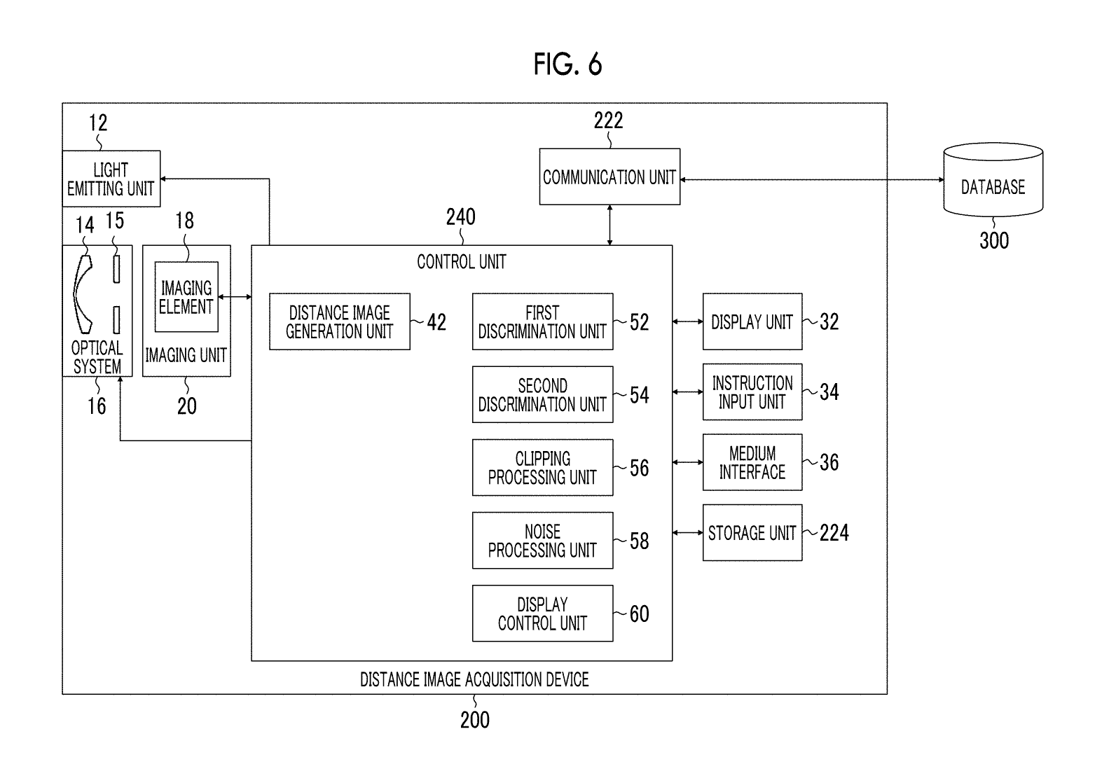

FIG. 6 is a block diagram illustrating an example of a configuration of a distance image acquisition device according to a second embodiment. Further, the same components as those of the first embodiment illustrated in FIG. 1 are denoted by the same reference numerals, and detailed description thereof will be omitted.

The distance image acquisition device 200 of the second embodiment includes a light emitting unit 12, an optical system 16, an imaging unit 20, a display unit 32, an instruction input unit 34, a medium interface 36, a communication unit 222, a storage unit 224, and a control unit 240.

The communication unit 222 includes a wired or wireless communication device, and performs output and input of information to and from an external device (the database 300 in this example). The storage unit 224 includes, for example, a ROM, a RAM, and an EEPROM, and stores various types of information. The control unit 240 includes, for example, a CPU. The control unit 240 includes a distance image generation unit 42, a first discrimination unit 52, a second discrimination unit 54, a clipping processing unit 56, a noise processing unit 58, and a display control unit 60. The control unit 240 executes a distance image generation process, a determination process, a clipping process, noise processing, and a display control process.

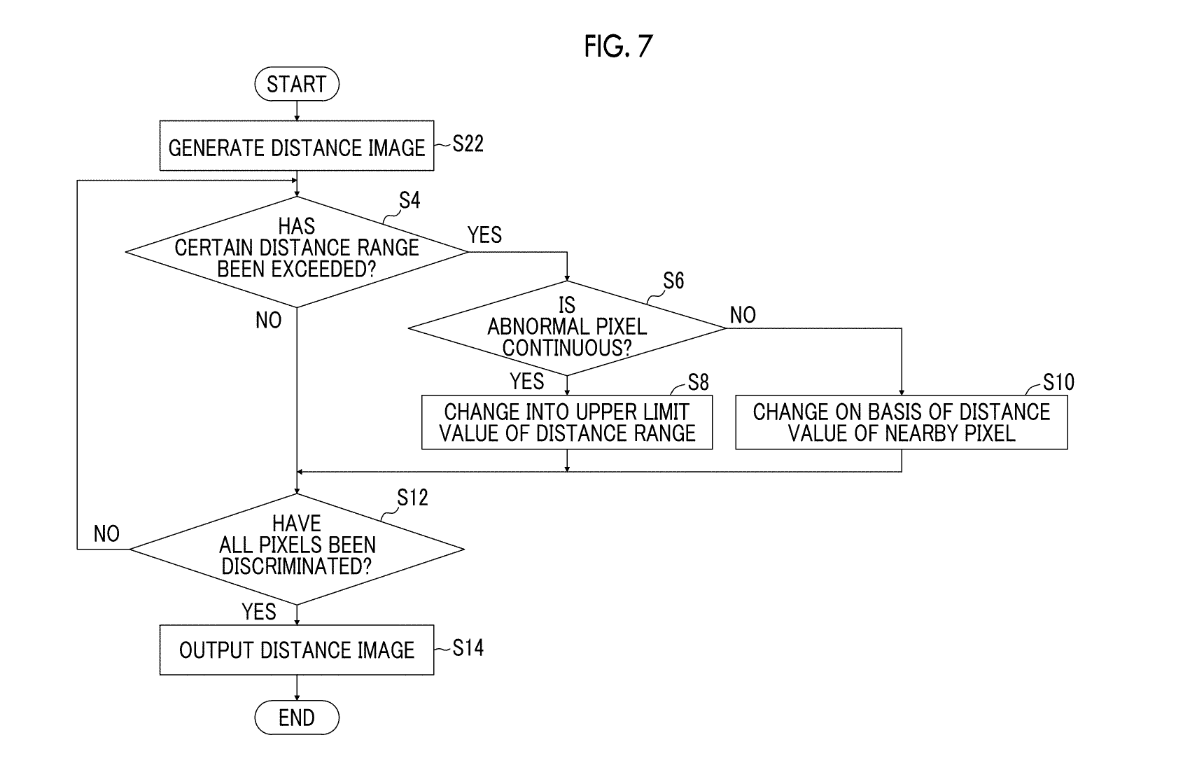

FIG. 7 is a flowchart showing a flow of an example of distance image processing in the second embodiment. The distance image processing of this example is executed by the control unit 240 of the distance image acquisition device 200 according to the program stored in the storage unit 224 of the distance image acquisition device 200. It should be noted that the same steps as those in the example of the distance image processing of the first embodiment illustrated in FIG. 2 are denoted by the same reference numerals, and detailed description thereof will be omitted.

In the embodiment, the distance image generation unit 42 of the distance image acquisition device 200 generates a distance image (step S22). The subsequent processes are the same as the steps S4 to S14 in the first embodiment illustrated in FIG. 2. The discrimination process (steps S4 and S6), the clipping process (step S8), and noise processing (step S10) are executed for the distance image. A determination is made as to whether or not all pixels of the distance image have been discriminated (step S12). In a case where there is a pixel which has not yet been discriminated (NO in step S12), the process returns to step S4, and in a case where all the pixels are discriminated (YES in step S12), the distance image in which the pixel value of the abnormal pixel has been changed is output (step S14).

### Modification Example of Discrimination

Modification examples of discrimination of the first discrimination unit 52 and the second discrimination unit 54 will be described.

Although the case where the threshold values for discrimination of the first discrimination unit 52 and the second discrimination unit 54 are fixed has been described by way of example in the first embodiment and the second embodiment described above in order to facilitate understanding of the present invention, the threshold values for discrimination may be variable.

<Threshold Value for First Discrimination Unit>

A threshold value for discrimination of the first discrimination unit 52 may be variable. That is, a threshold value for discriminating whether or not the pixel of interest of the distance image is an abnormal pixel (hereinafter referred to as a “threshold value for abnormal pixel discrimination”) is variable.

For example, the instruction input unit 34 receives a setting input of the upper limit value of the measurement distance range. The instruction input unit 34 of this example is one form of a “setting input unit” in the present invention. Using the upper limit value received by the instruction input unit 34 as the threshold value for abnormal pixel discrimination, the first discrimination unit 52 discriminates that the pixel of interest is the abnormal pixel in a case where the pixel value of the pixel of interest exceeds the upper limit value, which has been instructed and input.

<Threshold Value for Second Discrimination Unit>

A threshold value for discrimination of the second discrimination unit 54 may be variable. That is, a threshold value for discriminating whether or not a clipping process is to be performed on the abnormal pixel (hereinafter referred to as a “threshold value for process discrimination”) is variable. In other words, the second discrimination unit 54 switches between threshold values that are used for discrimination as to whether or not the pixel is the first abnormal pixel.

First, it is preferable for the second discrimination unit 54 to switch between the threshold value for process discrimination according to the upper limit value of the measurement distance range.

Second, it is preferable for the second discrimination unit 54 to switch between the threshold value for process discrimination according to imaging sensitivity in a case where the distance image has been acquired.

Modes for carrying out the present invention have been described above, the present invention is not limited to the embodiments and the modification examples described above, and various modifications are possible without departing from the gist of the present invention.

### EXPLANATION OF REFERENCES

10, 200: distance image acquisition device
12: light emitting unit
14: lens
15: aperture
16: optical system
18: imaging element
20: imaging unit
22: client communication unit
24: client storage unit
32: display unit
34: instruction input unit
36: medium interface
40: client control unit
42: distance image generation unit
52: first discrimination unit
54: second discrimination unit
56: clipping processing unit
58: noise processing unit
60: display control unit
100: distance image processing device
122: server communication unit
124: server storage unit
140: server control unit
222: communication unit
224: storage unit
240: control unit
300: database
Pi: pixel of interest
Ps1, Ps2, Ps3, Ps4, Ps5, Ps6, Ps7, Ps8: nearby pixels
W: window of interest

What is claimed is:

1. A distance image processing device comprising:
a distance image input unit that inputs a distance image including a plurality of pixels having a distance value corresponding to a time of flight of light from light emission to light reception;
a first discrimination unit that discriminates a pixel having a distance value exceeding a certain distance range among the plurality of pixels as an abnormal pixel;
a second discrimination unit that discriminates the abnormal pixel discriminated by the first discrimination unit as a first abnormal pixel that is continuous and a second abnormal pixel that is not continuous; and
a clipping processing unit that changes a distance value of the first abnormal pixel into a certain value.

2. The distance image processing device according to claim 1,
wherein the certain value is an upper limit value of the certain distance range, and
the clipping processing unit changes the distance value of the first abnormal pixel into the upper limit value of the distance range.

3. The distance image processing device according to claim 1, further comprising:
a noise processing unit that changes a distance value of the second abnormal pixel on the basis of distance values of pixels around the second abnormal pixel.

4. The distance image processing device according to claim 1, wherein the second discrimination unit performs discrimination as to whether or not the abnormal pixel is the first abnormal pixel on the basis of the number of the abnormal pixels in an area having a fixed size with reference to each of the abnormal pixels discriminated by the first discrimination unit.

5. The distance image processing device according to claim 1, wherein the second discrimination unit switches a threshold value that is used for discrimination as to whether or not the abnormal pixel is the first abnormal pixel according to an upper limit value of the distance range.

6. The distance image processing device according to claim 1, wherein the second discrimination unit switches a threshold value that is used for discrimination as to whether or not the abnormal pixel is the first abnormal pixel according to imaging sensitivity in a case where the distance image is acquired.

7. The distance image processing device according to claim 1, further comprising:
a setting input unit that receives a setting input of the certain value.

8. The distance image processing device according to claim 3, wherein the noise processing unit performs noise processing using a smoothing filter or a median filter.

9. The distance image processing device according to claim 1, further comprising:
a display control unit that causes a display device to display the plurality of pixels of the distance image with colors according to the respective distance values.

10. A distance image acquisition device comprising:
a light emitting unit that emits light;
an imaging unit that includes a light reception surface on which a plurality of light reception elements are arranged;
an optical system that guides the light emitted from the light emitting unit and reflected in a distance measurement area to the light reception surface of the imaging unit;
a distance image generation unit that generates a distance image including a plurality of pixels having distance values corresponding to a time of flight of light from light emission of the light emitting unit to the light reception surface of the imaging unit on the basis of an imaging result of the imaging unit;
a first discrimination unit that discriminates the pixel having the distance value exceeding a certain distance range among the plurality of pixels as an abnormal pixel;
a second discrimination unit that discriminates the abnormal pixel discriminated by the first discrimination unit as a first abnormal pixel that is continuous and a second abnormal pixel that is not continuous; and
a clipping processing unit that changes a distance value of the first abnormal pixel into a certain value.

11. The distance image acquisition device according to claim 10, wherein the certain value is an upper limit value of the certain distance range.

12. The distance image acquisition device according to claim 10, further comprising:
a noise processing unit that changes a distance value of the second abnormal pixel on the basis of distance values of pixels around the second abnormal pixel.

13. A distance image processing method comprising the steps of:
inputting a distance image including a plurality of pixels having a distance value corresponding to a time of flight of light from light emission to light reception;
discriminating a pixel having a distance value exceeding a certain distance range among the plurality of pixels as an abnormal pixel;
discriminating the discriminated abnormal pixel as a first abnormal pixel that is continuous and a second abnormal pixel that is not continuous; and
changing a distance value of the first abnormal pixel into a certain value.

14. The distance image processing method according to claim 13, wherein the certain value is an upper limit value of the certain distance range.

15. The distance image processing method according to claim 13, further comprising the step of:
changing a distance value of the second abnormal pixel on the basis of distance values of pixels around the second abnormal pixel.
